(19) United States
(12) Patent Application Publication
(10) Pub. No.: US 2023/0273437 A1
(43) Pub. Date: Aug. 31, 2023

(54) EFFICIENT PANCAKE LENS FOR PERIPHERAL VIEW IN VIRTUAL REALITY HEADSETS

(71) Applicant: Meta Platforms Technologies, LLC, Menlo Park, CA (US)

(72) Inventors: Jian Xu, Redmond, WA (US); Jacques Gollier, Sammamish, WA (US); Ying Geng, Bellevue, WA (US)

(21) Appl. No.: 18/158,842

(22) Filed: Jan. 24, 2023

Related U.S. Application Data
(60) Provisional application No. 63/314,031, filed on Feb. 25, 2022.

(51) Int. Cl. G02B 27/01; G02B 27/09; G02B 27/28

(52) U.S. Cl. CPC G02B 27/0172; G02B 27/0983; G02B 27/286; G02B 27/44; G02B 2027/0174

(57) ABSTRACT

A virtual reality headset includes a peripheral display including light emitting pixels, an eyebox delimiting a location of a pupil in a user’s eye, and an optical assembly. The optical assembly includes an angularly selective element configured to transmit, without reflecting, an input light impinging at a selected angle, through a first curved optical element, and a second curved optical element in optical series with the first curved optical element and configured to reflect the input light back to the first curved optical element, the first curved optical element reflecting the input light in a radial direction, for transmission through the second curved optical element.

### CROSS-REFERENCE TO RELATED APPLICATIONS

The present disclosure is related to and claims priority under 35 U.S.C. §119(e) to US Prov. Appln. 63/314031, entitled EFFICIENT PANCAKE LENS FOR PERIPHERAL VIEW IN VIRTUAL REALITY HEADSETS, to Jian XU, et al., filed on Feb. 25, 2022, the contents of which are hereby incorporated by reference hereinafter, in their entirety, and for all purposes.

### BACKGROUND

### Field

The present disclosure is related to headsets for use in virtual reality (VR) applications that include peripheral view. More specifically, the present disclosure is related to headsets that provide a fully immersive experience to viewers using a pancake lens.

### Related Art

In the field of virtual reality headsets, much focus is devoted to the binocular field of view (FOV) of the user, which includes about 60° up, 50° nasally and peripherally, and 75° down. This is about 2.5 Sr. Current VR devices support most of this binocular (or “stereo”) portion of the field of view, but service very little of the periphery (visible to one eye only) or the lower binocular field. To provide a fully immersive experience to viewers, incorporating large portions of the peripheral view is desirable. Human vision includes a peripheral field of view that is more than 200° horizontal and more than 115° vertical (about 5.3 Sr total). Current optical applications are unable to incorporate this peripheral field of view (FOV) in a compact, light headset that a viewer can comfortably use and move around with.

Pancake lenses are compact optical devices providing a high numerical aperture (NA) and resolution with reduced aberrations, and thus desirable to handle peripheral displays. However, typical pancake lenses are inefficient (about 25% throughput) due to their polarization dependence. This drawback has prevented pancake lenses from being used in peripheral display applications.

### SUMMARY

An optical assembly includes an angularly selective element configured to transmit, with a substantially reduced reflection, an input light impinging at a selected angle, through a first curved optical element. The optical assembly also includes a second curved optical element in optical series with the first curved optical element and configured to reflect the input light back to the first curved optical element, the first curved optical element reflecting the input light in a radial direction, for transmission through the second curved optical element towards a curvature center of the optical assembly.

A virtual reality headset includes a peripheral display including light emitting pixels, an eyebox delimiting a location of a pupil in a user’s eye, and an optical assembly. The optical assembly includes an angularly selective element configured to transmit, without reflecting, an input light impinging at a selected angle, through a first curved optical element, and a second curved optical element in optical series with the first curved optical element and configured to reflect the input light back to the first curved optical element, the first curved optical element reflecting the input light in a radial direction, for transmission through the second curved optical element.

A method includes directing a light beam from a peripheral display onto an angularly selective element at a first angle of incidence, the first angle of incidence selected according to a position of an emitter in the peripheral display and an incident position on a pancake lens adjacent to the angularly selective element. The method also includes transmitting the light beam through a first curved optical element and a second curved optical element in the pancake lens, after a first reflection at the second curved optical element and second reflection at the first curved optical element, and directing the light beam to an eyebox delimiting a pupil position of a user in a virtual reality headset.

These and related embodiments will become clear in light of the following.

### BRIEF DESCRIPTION OF THE FIGURES

FIG. 1 illustrates an exemplary VR headset, according to some embodiments.

FIG. 2 illustrates a pancake lens for use with a peripheral display to increase the FOV of a VR headset, according to some embodiments.

FIG. 3 illustrates a ray tracing example in a pancake lens optimized for high transmission efficiency, according to some embodiments.

FIG. 4 illustrates an angularly selective element to increase the efficiency of a pancake lens, according to some embodiments.

FIG. 5 illustrates the principle of operation of a volume Bragg grating (VBG) and a multiplexed VBG, compared to a mirror, according to some embodiments.

FIG. 6 illustrates a pancake lens including a VBG layer to increase optical efficiency between the peripheral display and the eyebox, according to some embodiments.

FIG. 7 illustrates a chart with a conversion efficiency for a given wavelength and angle of incidence on a VBG layer for use in a pancake lens, according to some embodiments.

FIG. 8 illustrates a VR headset including an eye tracking device in a central portion of the display, according to some embodiments.

FIG. 9 illustrates a pancake lens configured to provide a peripheral view to the user of a VR headset, according to some embodiments.

FIG. 10 is a flow chart illustrating steps in a method for providing a peripheral view with a pancake lens for a user of a VR headset, according to some embodiments.

FIG. 11 is a block diagram illustrating an exemplary computer system with which a VR headset, and methods of use can be implemented, according to some embodiments.

In the figures, elements and components having the same or similar label share the same or similar features, unless expressly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

In the field of virtual reality headsets, a peripheral field of view is desirable to provide the viewer with a fully immersive experience. While the angular resolution for a wide field of view is less restrictive (human vision is naturally less acute in the periphery), it is desirable to have systems that provide a wide FOV with reasonable good resolution (e.g., less than 10 arcminutes, and preferably less than 5 arcminutes). Pancake lenses have been used to provide high NA optics and angular resolution in a compact format. Additionally, the extra internal reflections that extend the optical path within the pancake lenses compensate field curvature caused by refraction, thus reducing the associated aberrations.

Pancake lenses as disclosed herein mitigate field curvature aberrations and accordingly acts to reduce pupil swim within the eyebox. Field curvature is an optical aberration that causes a flat object to appear sharp only in a certain part(s) of the frame, instead of being uniformly sharp across the frame. More generally, field curvature is a result of a focal distance of an optics system not perfectly aligning with all the points on a focal plane. Pupil swim is the effect caused by changes in the location of a user’s eye within an eyebox, and results in distortions of the content being presented to the user. Correcting for field curvature mitigates pupil swim. Additionally, pancake lens assembly has a small form factor, is relatively low weight compared to other optical systems designed to remove field curvature, and is configured to have a wide field of view, shorter focal distance, and higher optical power. However, pancake lenses have the drawback that their polarization dependence make them highly inefficient (e.g., about 25%).

To resolve the above technical problem, embodiments as disclosed herein provide an efficient pancake lens for peripheral display in a VR device. The pancake lens includes an angularly sensitive layer on a surface of the pancake lens that receives incoming light from the peripheral display. The angularly sensitive layer is configured to substantially reduce reflectivity at a desired angle of incidence and wavelength. In some embodiments, the angularly sensitive layer may include a holographic layer, or a Bragg grating layer.

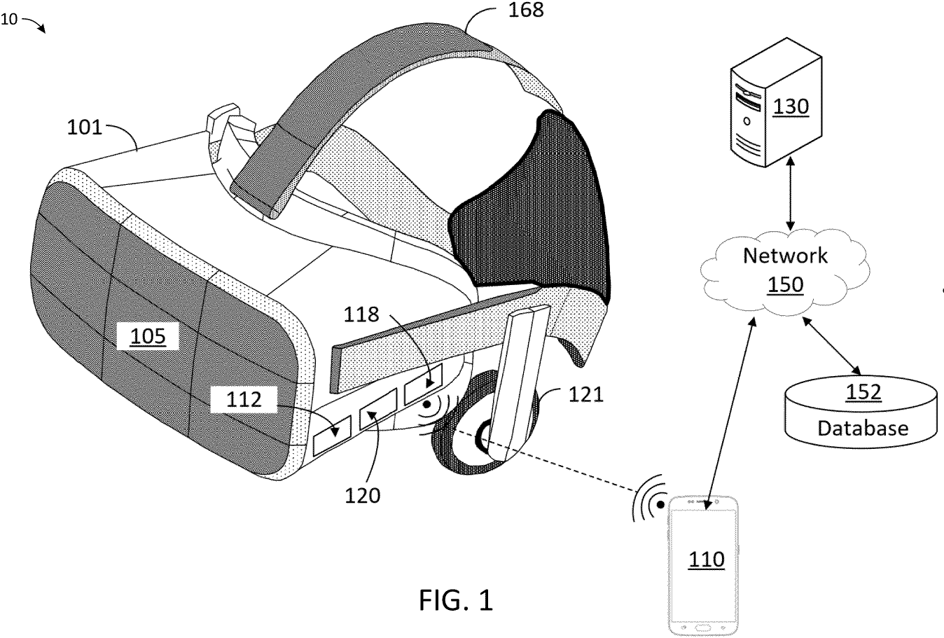

FIG. 1 illustrates an exemplary VR headset 10, according to some embodiments. VR headset 10 may include a front panel 105, a visor 101, and a strap 168. Front panel 105 includes and protects a display for the user, visor 105 adjusts VR headset 10 on the user, and strap 168 keeps VR headset 10 tightly fit on the user’s head. An audio device 121 provides sound and audio signals and messages to the user.

In some embodiments, VR headset 10 may include a processor 112 and a memory 120. Memory 120 may store instructions which, when executed by processor 112, cause VR headset 10 to execute a method as disclosed herein. In addition, VR headset 10 may include a communications module 118 having radio-frequency software and hardware configured to wirelessly communicate processor 112 and memory 120 with an external network 150, or a mobile device 110 for the user. External network 150 may also include a remote server 130 hosting an application installed in mobile device 110, for controlling VR headset 10, and a database 152 storing data associated with VR headset 10, the user, and other users in network 150. Accordingly, communications module 118 may include radio antennas, transceivers, and sensors, and also digital processing circuits for signal processing according to any one of multiple wireless protocols such as Wi-Fi, Bluetooth, Near field contact (NFC), and the like. In addition, communications module 118 may also communicate with other input tools and accessories cooperating with VR headset 10 (e.g., handle sticks, joysticks, mouse, wireless pointers, and the like).

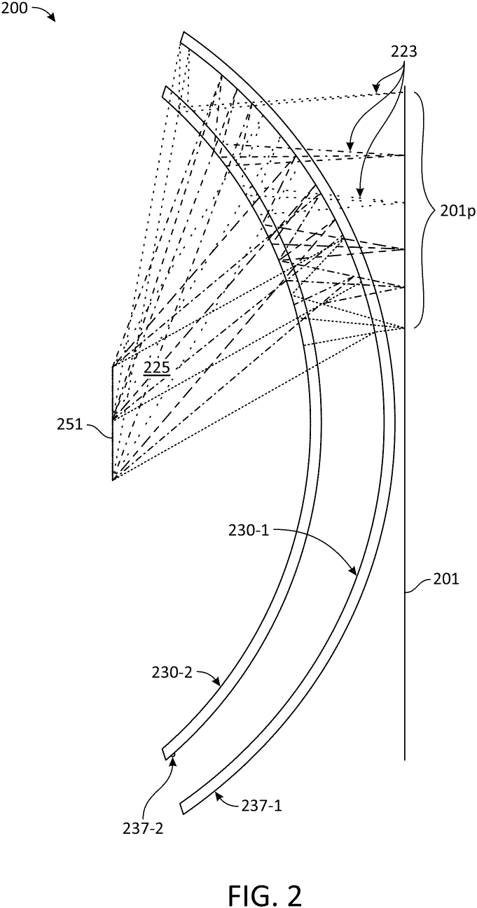

FIG. 2 illustrates a pancake lens 200 for use with a peripheral display 201p to increase the FOV of a VR headset, according to some embodiments. Peripheral display 201p may be part of an overall display 201 that provides input light 223 to pancake lens 200, which in turn directs output light 225 to an eyebox 251 that delimits the position of the user’s pupil. More specifically, pancake lens 200 includes a first curved optical element 237-1, and a second curved optical element 237-2 (hereinafter, collectively referred to as “curved optical elements 237”) in an optical series with first curved optical element 237-1 and configured to reflect input light 223 back to first curved optical element 237-1, which reflects input light 223 in a radial direction for transmission through second curved optical element 237-2. A first and second waveplates 230-1 and 230-2 (hereinafter, collectively referred to as “waveplates 230”) are configured to rotate the linear polarization of incoming light 223 generated by the peripheral display 201p such that a first bounce of a reflective polarizer reflects an incoming beam back to a first surface of pancake lens 200, wherein the beam is again reflected towards eyebox 251. In a second pass through the second waveplate 230-2, outgoing beam 225 is rotated to an orthogonal polarization such that the reflective polarizer is transparent to outgoing beam 225, which proceeds to eyebox 251.

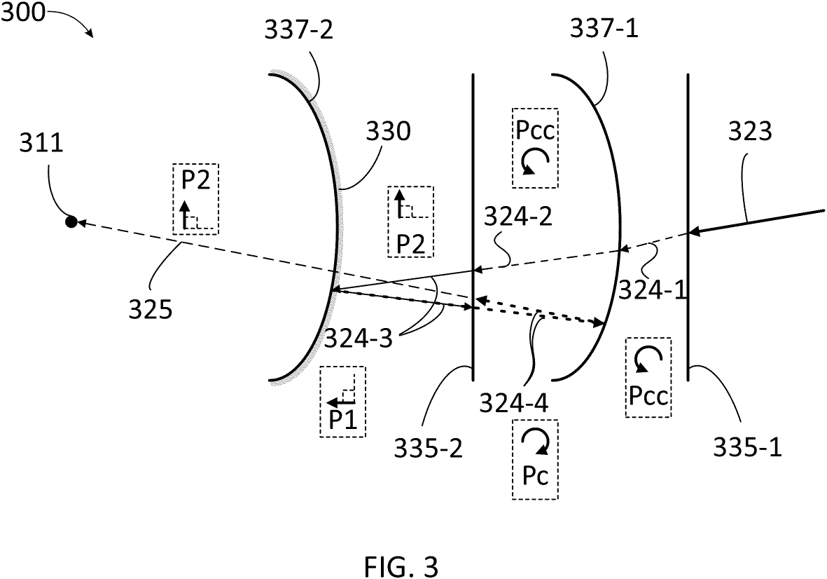

FIG. 3 illustrates a ray tracing example in a pancake lens 300 optimized for high transmission efficiency, according to some embodiments. An incoming light beam 323 may be generated by an electronic display screen. In some embodiments, incoming light 323 is linearly polarized. A first waveplate 335-1 (e.g., a quarter-waveplate, λ/4) converts the linearly polarized input light beam 323 into circularly polarized light 324-1, e.g., counter-clockwise, Pcc (or clockwise, Pc), based on the orientation of the axis of first waveplate 335-1 relative to the incident linearly polarized light 323. Incoming light beam 323 is transmitted by a first curved optical element 337-1 towards a second waveplate 335-2 (hereinafter, waveplates 335-1 and 335-2 will be collectively referred to as “waveplates 335”). In some embodiments, the first curved optical element is configured to transmit 100% of incident light, e.g., via an angularly selective layer, when the incident light beam has a selected angle of incidence.

Waveplate 335-2 may be a quarter-waveplate that changes the polarization of incident light beam 324-1 from circular back to a selected linear polarization P1. Light beam 324-3, with polarization P1, is incident on a second curved optical element 337-1 (hereinafter, curved optical elements 337-1 and 337-2 will be collectively referred to as “curved optical elements 337”). Second curved optical element 337-2 may include a reflective polarizer 330 that reflects light with P1 polarization (e.g., light beam 324-3), and transmits light 324-4 with the orthogonal polarization, P2. At this point, the light beam 324-3 with polarization P1 is reflected off of second curved optical element 337-2 back to second waveplate 335-2, which changes the linear polarization from P1 to a circularly polarized light Pc 324-4 (clockwise, and opposite to the initial circular polarization due to the reflection from second curved optical element 337-2) and first curved optical element 337-1 reflects the polarized light, Pc, back to second waveplate 335-2, which changes the polarization of circularly polarized light Pc to linearly polarized light, P2, orthogonal to P1. Accordingly, light P2 325 is transmitted by reflective polarizer 330 and exits pancake lens 300 towards its center of curvature (e.g., within the eyebox).

Light beams 324-1, 324-2, 324-3, and 324-4 (hereinafter, collectively referred to as “light beam 324”) propagating through pancake lens 300 thus undergoes multiple reflections between the first curved optical element and the second curved optical element, and passes through multiple materials and layers (e.g., waveplates, reflectors, glass, air, and the like) each having different indices of refraction. In some embodiments, these materials can be chosen to allow pancake lens 300 to remove field curvature at the outgoing light beam 325. For example, field curvature may be minimized by designing the different layers of curved optical elements 337 to have radii, and indices or refraction that minimize the Petzval Sum:

$${\sum }_{i} \frac{{n}_{i + 1} - {n}_{i}}{{r}_{i} ⋅ {n}_{i + 1} ⋅ {n}_{i}} \qquad \text{(1)}$$

where rᵢ’s and the nᵢ’s are the radius of curvature and the indices of refraction of each layer across the pancake lens. Further, minimizing the distance between a center of curvature (which may or may not be the same for both optical curved surfaces) and a user’s pupils minimizes the field curvature distortion observed by the user. Thus, in some embodiments, the center of curvature 311 of pancake lens 300 is positioned as near as reasonably possible to the pupil of a user’s eyes (cf., within eyebox 251).

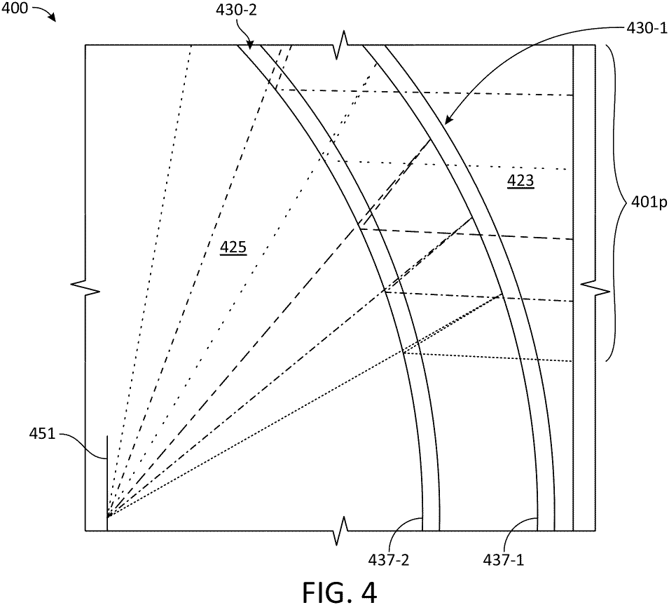

FIG. 4 illustrates angularly selective elements 430-1 and 430-2 (collectively referred, hereinafter, as “angularly selective elements 430”) to increase the efficiency of a pancake lens 400, according to some embodiments. Pancake lens 400 includes an angularly selective element 430-1 configured to transmit, without reflecting, an input light 423 impinging at a selected angle. Angularly selective elements 430 may include a holographic optical element (HOE) and/or a volume Bragg grating (VBG). Note that angularly selective elements 430 provide output beams 425 onto eyebox 451 that may not necessarily be a beam coming at a reflection angle relative to a surface normal of the pancake lens at the angularly selective element. In addition, pancake lens 400 also includes a first curved optical element 437-1 and a second curved optical element 437-2 (hereinafter, collectively referred to as “curved optical elements 437”) in optical series with first curved optical element 437-1 and configured to reflect input light 423 back to the first curved optical element 437-1, which reflects input light 423 in a radial direction, for transmission through second curved optical element 437-2.

In some embodiments, angularly selective elements 430 are configured to transmit input light 423 impinging at the selected angle in a direction with respect to second curved optical element 437-2 such that input light 423 reflected from second curved optical element 437-2 is directed in a substantially radial direction relative to first curved optical element 437-1. In some embodiments, input light 423 is generated by a peripheral display 401p, and angularly selective elements 430 are azimuthally graded so that input light 423 from different portions of peripheral display 401p is transmitted through first curved optical element 437-1 toward second curved optical element 437-2 and then reflected from second curved optical element 437-2 toward first curved optical element 437-1 in a substantially radial direction relative to first curved optical element 437-1.

In some embodiments, peripheral display 401p includes light emitting pixels generating light comprising a narrow bandwidth, a polarization direction, and a beam direction in a selected angle. This can be achieved with lasers, or light emitting diodes (LEDs) including filters and light directing elements such as micro-electro-mechanic components (MEMs), and the like. The narrow bandwidth and high directionality of laser beams make them well suited to interact with angularly selective elements 430 to produce a transmission efficiency for the selected beam of almost 100%, and a reflectivity of almost 100% for laser beams having a different wavelength or impinging on first curved optical element 437-1 in a slightly different direction from the selected direction.

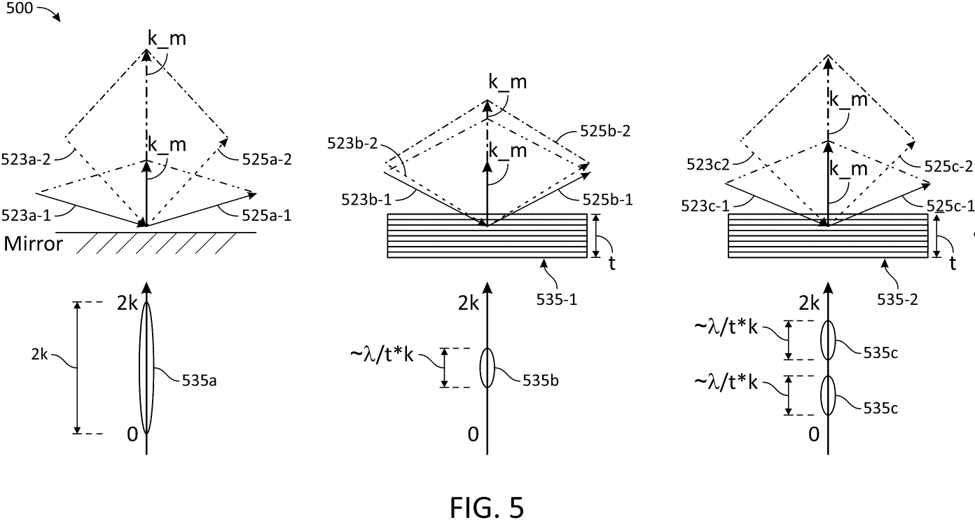

FIG. 5 illustrates the principle of operation of volume Bragg gratings (VBG) 535-1 and a multiplexed VBG 535-2 (hereinafter, collectively referred to as “VBGs 535”), compared to a mirror, according to some embodiments. For a mirror, for example, regardless of the angle of incidence (polarization state notwithstanding), incident beams 523a-1 and 523a-2 (hereinafter, collectively referred to as “incident beams 523a”) render reflected beams 525a-1 and 525a-2 (hereinafter, collectively referred to as “reflected beams 525a”) with a relatively high efficiency, over a wide bandwidth (e.g., the entire visible bandwidth from about 400 nm to about 700 nm). Thus, depending on the angle of incidence (e.g., 90 degrees from the normal to zero degrees from the normal), the mirror can impart a total wavevector 535a of a magnitude between 0 and 2k to an incident beam with wavevector k (=2·n·π/λ, where n is the index of refraction of the medium, and λ is the wavelength of the light forming the beam).

For VBG 535-1 of thickness, t, and pitch, A, the bandwidth of reflectivity 535b for an incident beam with wavevector, k, will be proportional to the ratio λ/t·k. Accordingly, the range of incident beams 523b-1 and 523b-2 (hereinafter, collectively referred to as “incident beams 523b”) resulting in reflected beams 525b-1 and 525b-2 (hereinafter, collectively referred to as “reflected beams 525b”) is narrower than that of a mirror. In some embodiments, to provide higher reflectivity at different wavelengths, multiplexed VBG 535-2 may include multiple Bragg gratings of thicknesses t₁, t₂, t₃ (and more, if desired), each having a different pitch Λ₁, Λ₂, Λ₃, in a multilayered structure. Accordingly, VBG 535-2 increases the phase-space bandwidth 535c of incident/reflected beams 523c-1, 523c-2 (hereinafter, collectively referred to as “incident beams 523c”)/525c-1, 525c-2 (hereinafter, collectively referred to as “incident beams 525c”), respectively.

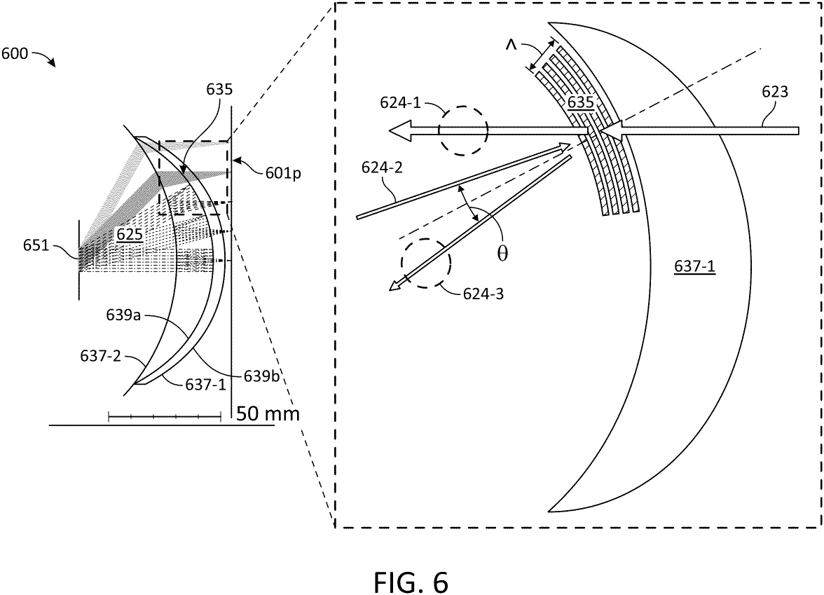

FIG. 6 illustrates a pancake lens 600 including curved elements 637-1 and 637-2 (hereinafter, collectively referred to as “curved elements 637”), VBG layer 635 on surface 639a to increase optical efficiency between a peripheral display 601p, and an eyebox 651, according to some embodiments. VBG 635 has a pitch, A, and acts as a highly efficient reflector for light coming in from curved element 637-2 at an angle θ (which makes it close to normal incidence at the point of contact with the surface of VBG 635, according to ray tracing). Surface 639b is transparent to incoming light at a higher angle of incidence (e.g., coming from peripheral display 601p). Thus, light 624-1 from peripheral display 601p will go through curved element 637-1, but light 624-2 coming back to lens 637-1 from lens 637-2 will be reflected not light 624-3 at a highly efficient rate, as desired. Light 624-5 will go through curved element 637-2 into eyebox 651.

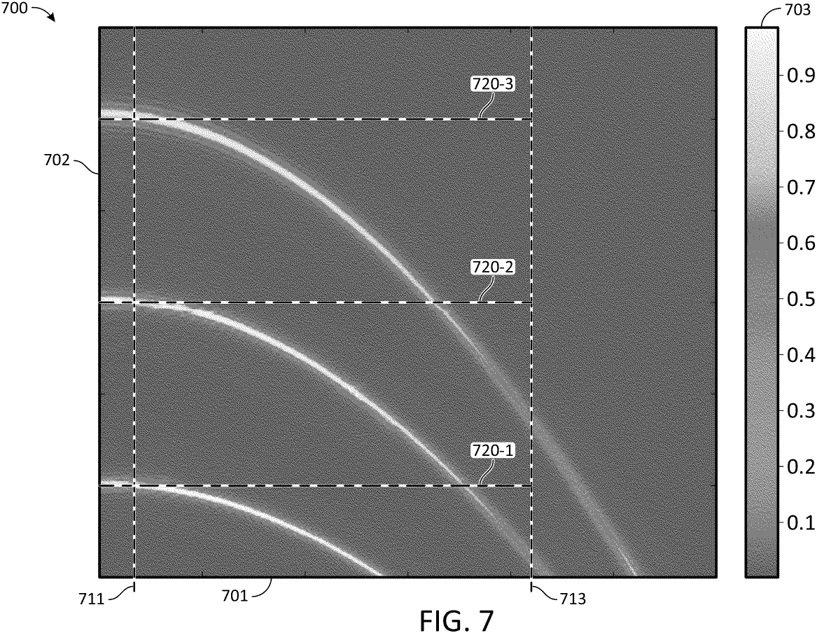

FIG. 7 illustrates a chart 700 with a conversion efficiency for a given wavelength 702 and angle of incidence 701 on a multiplexed VBG layer for use in a pancake lens, according to some embodiments. In some embodiments, the multiplexed VBG surface may include three different VBG layers optimized in reflectivity efficiency for each of three different wavelengths 720-1, 720-2, and 720-3 (hereinafter, collectively referred to as “wavelengths 720”) that may be superimposed to one another to operate with an RGB display. Accordingly, as shown in chart 700, each of the three VBG layers is optimized with a pitch A for wavelengths 720-1 (λ₁) ~ 450 nm (Blue), 720-2 (λ₂) ~ 550 nm (Green), and 720-3 (λ₃) ~ 650 nm (Red). As shown, the minimum angle of incidence 711 (based on ray tracing, cf. FIG. 6) will be ~5°, and definitely less than ~ 10°, which gives a reflection efficiency of greater than 90% for the three colors from the display (RGB). For the three VBG layers, chart 700 also illustrates the total internal reflection (TIR) angle cutoff 713 for a material with refractive index ~ 1.5 (~42°). A grayscale 703 indicates efficiency in a range from 0% to 100%.

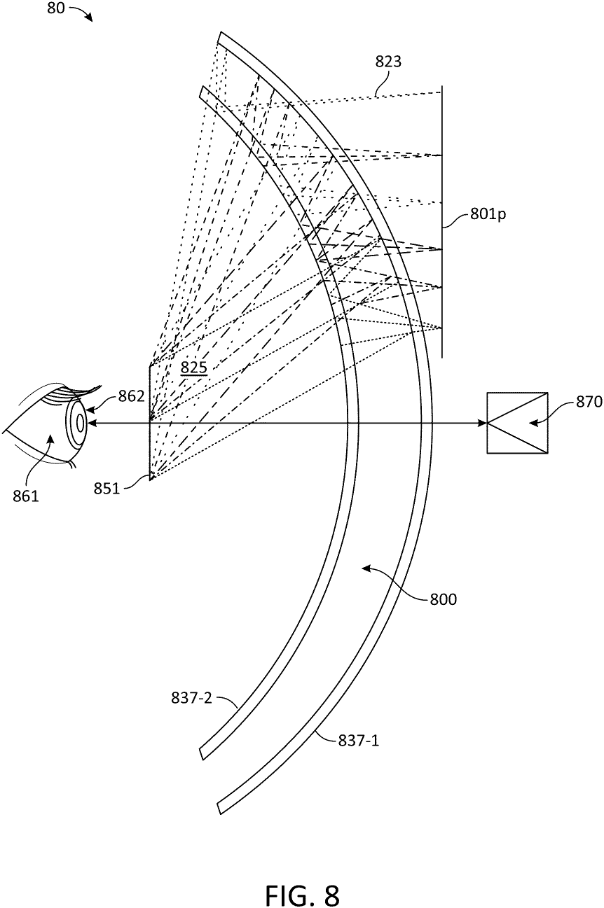

FIG. 8 is a partial view of a VR headset 80 including a pancake lens 800 and an eye tracking device 870 in a central portion, according to some embodiments. A peripheral display 801p provides incident beams 823. Display 801p covers portions of the FOV of the user away from the central portion of pancake lens 800. Output beams 825 are directed to eyebox 851. Eye tracking device 870 has a direct access to the user’s eye 861, e.g., via an ultrasonic beam, or an infrared (IR) beam, and the like. VR headset 80 may significantly simplify the implementation of eye tracking techniques both in hardware and software and center an eyebox 851 within the position of the user’s pupil 862. Pancake lens 800 includes a first curved element 837-1 and a second curved element 837-2.

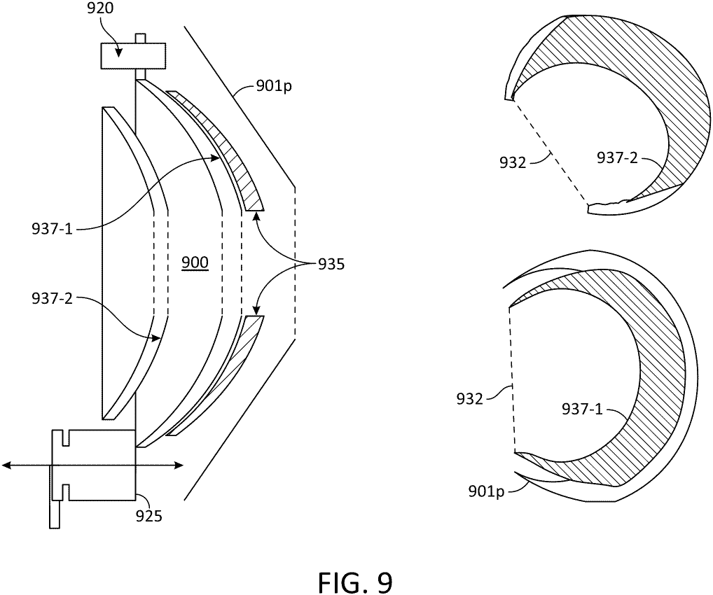

FIG. 9 illustrates a pancake lens 900 configured to provide a peripheral view to the user of a VR headset, according to some embodiments. Pancake lens 900 may include a first optical element 937-1 and a second optical element 937-2 (hereinafter, collectively referred to as “optical elements 937”) disposed at a selected distance from a conic display 901p and have a crescent shape around an eyepiece in a VR headset with a gap 932 in the area adjacent to the user’s nose. An angularly sensitive element 935 on the side of optical element 937-1 lets optical rays from peripheral display 901p through, and reflects back optical beams from optical element 937-2.

A mount 920 for the first curved optical element and a linear actuator 925 may adjust the radius of curvature of optical elements 937, and their center of curvature. Conical display 901p may enable a closer and more homogeneous distance distribution between pixels in the conic display and incident points in an angularly sensitive element 935 adjacent to optical element 937-1.

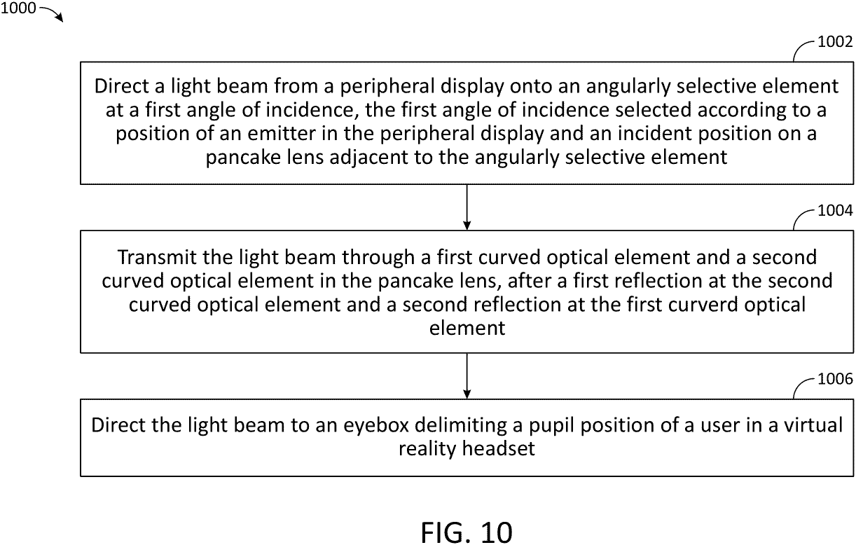

FIG. 10 is a flow chart illustrating steps in a method 1000 for providing a peripheral view with a pancake lens for a user of a VR headset, according to some embodiments. Methods consistent with method 1000 may include one or more steps at least partially performed by a processor circuit executing instructions stored in a memory, as disclosed herein. In some embodiments, the processor may be in a VR headset, in a mobile device, or in a remote server. The VR headset may be communicatively coupled to the mobile device via a wireless channel through a communications module. The mobile device may be coupled with the remote server via a network. In some embodiments, at least some steps in method 1000 may be performed by the user of the VR headset via an application installed in the mobile device. Moreover, data provided to the VR headset, or from the VR headset while performing method 1000 may be stored in a database communicatively coupled with the mobile device and the remote server via the network. In some embodiments, the VR headset may include a peripheral display and a pancake lens assembly configured to collect an image from the peripheral display, as disclosed herein.

Step 1002 includes directing a light beam from a peripheral display onto an angularly selective element at a first angle of incidence, the first angle of incidence selected according to a position of an emitter in the peripheral display and an incident position on a pancake lens adjacent to the angularly selective element. In some embodiments, step 1002 includes reflecting a second light beam coming to the incident position at a second angle of incidence that is different from the first angle of incidence. In some embodiments, the emitter of the peripheral display is a laser, and step 1002 includes directing the laser with a microelectromechanical component.

Step 1004 includes transmitting the light beam through a first curved optical element and a second curved optical element in the pancake lens, after a first reflection at the second curved optical element and second reflection at the first curved optical element. In some embodiments, step 1004 includes rotating a linear polarization of the light beam from a first polarization state to a second polarization state that is orthogonal to the first polarization state between the first curved optical element and the second curved optical element.

Step 1006 includes directing the light beam to an eyebox delimiting a pupil position of a user in a virtual reality headset. In some embodiments, step 1006 includes polarizing the light beam in a linear polarization state. In some embodiments, step 1006 includes directing a pupil finding beam from an eye tracking device adjacent to the peripheral display towards a user’s eye to identify a location of the user’s pupil within the eyebox.

### Hardware Overview

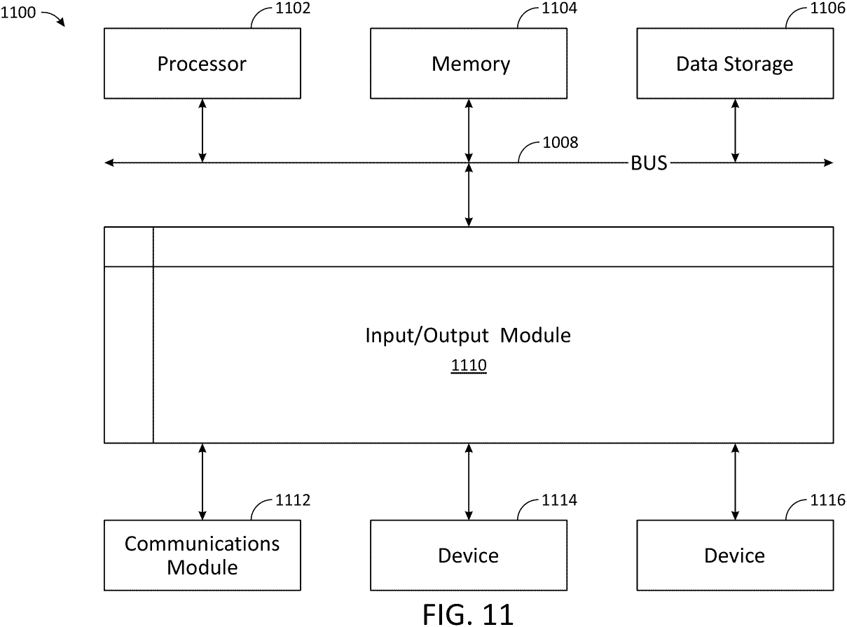

FIG. 11 is a block diagram illustrating an exemplary computer system 1100 with which a VR headset, and methods of use can be implemented, according to some embodiments. In certain aspects, computer system 1100 may be implemented using hardware or a combination of software and hardware, either in a dedicated server, or integrated into another entity, or distributed across multiple entities. Computer system 1100 may include a desktop computer, a laptop computer, a tablet, a phablet, a smartphone, a feature phone, a server computer, or otherwise. A server computer may be located remotely in a data center or be stored locally.

Computer system 1100 includes a bus 1108 or other communication mechanism for communicating information, and a processor 1102 coupled with bus 1108 for processing information. By way of example, the computer system 1100 may be implemented with one or more processors 1102. Processor 1102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1100 can include, in addition to hardware, code that creates an execution environment for the computer program in question, e.g., code that constitutes processor firmware, a protocol stack, a database management system, an operating system, or a combination of one or more of them stored in an included memory 1104, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 1108 for storing information and instructions to be executed by processor 1102. The processor 1102 and the memory 1104 can be supplemented by, or incorporated in, special purpose logic circuitry.

The instructions may be stored in the memory 1104 and implemented in one or more computer program products, e.g., one or more modules of computer program instructions encoded on a computer-readable medium for execution by, or to control the operation of, the computer system 1100, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, offside rule languages, procedural languages, reflective languages, rule-based languages, scripting languages, stack-based languages, synchronous languages, syntax handling languages, visual languages, wirth languages, and xml-based languages. Memory 1104 may also be used for storing temporary variable or other intermediate information during execution of instructions to be executed by processor 1102.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1100 further includes a data storage device 1106 such as a magnetic disk or optical disk, coupled with bus 1108 for storing information and instructions. Computer system 1100 may be coupled via input/output module 1110 to various devices. Input/output module 1110 can be any input/output module. Exemplary input/output modules 1110 include data ports such as USB ports. The input/output module 1110 is configured to connect to a communications module 1112. Exemplary communications modules 1112 include networking interface cards, such as Ethernet cards and modems. In certain aspects, input/output module 1110 is configured to connect to a plurality of devices, such as an input device 1114 and/or an output device 1116. Exemplary input devices 1114 include a keyboard and a pointing device, e.g., a mouse or a trackball, by which a consumer can provide input to the computer system 1100. Other kinds of input devices 1114 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 1116 include display devices, such as an LCD (liquid crystal display) monitor, for displaying information to the consumer.

According to one aspect of the present disclosure, a VR headset as disclosed herein can be implemented, at least partially, using a computer system 1100 in response to processor 1102 executing one or more sequences of one or more instructions contained in memory 1104. Such instructions may be read into memory 1104 from another machine-readable medium, such as data storage device 1106. Execution of the sequences of instructions contained in main memory 1104 causes processor 1102 to perform the process steps described herein. One or more processors in a multi-processing arrangement may also be employed to execute the sequences of instructions contained in memory 1104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1100 can include clients and servers. A client and server are generally remote from each other and typically interact through a communication network. The relationship of client and server arises by virtue of computer programs running on the respective computers and having a client-server relationship to each other. Computer system 1100 can be, for example, and without limitation, a desktop computer, laptop computer, or tablet computer. Computer system 1100 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1102 for execution. Such a medium may take many forms, including, but not limited to, non-volatile media, volatile media, and transmission media. Non-volatile media include, for example, optical or magnetic disks, such as data storage device 1106. Volatile media include dynamic memory, such as memory 1104. Transmission media include coaxial cables, copper wire, and fiber optics, including the wires forming bus 1108. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

The subject technology is illustrated, for example, according to various aspects described below. Various examples of aspects of the subject technology are described as numbered claims (claim 1, 2, etc.) for convenience. These are provided as examples and do not limit the subject technology.

In one aspect, a method may be an operation, an instruction, or a function and vice versa. In one aspect, a claim may be amended to include some or all of the words (e.g., instructions, operations, functions, or components) recited in either one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the user technology, the disclosure, the present disclosure, other variations thereof and alike are for convenience only and do not imply that a disclosure relating to such phrase(s) is essential to the user technology or that such disclosure applies to all configurations of the user technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the user technology, and are not referred to in connection with the interpretation of the description of the user technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the user technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the user matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can, in some cases, be excised from the combination, and the described combination may be directed to a subcombination or variation of a subcombination.

The user matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An optical assembly, comprising:
an angularly selective element configured to transmit, with a substantially reduced reflection, an input light impinging at a selected angle, through a first curved optical element; and
a second curved optical element in optical series with the first curved optical element and configured to reflect the input light back to the first curved optical element, the first curved optical element reflecting the input light in a radial direction, for transmission through the second curved optical element towards a curvature center of the optical assembly.

2. The optical assembly of claim 1, wherein the angularly selective element includes one of a holographic layer, a volume Bragg grating, or a surface relief grating.

3. The optical assembly of claim 1, wherein the angularly selective element is configured to transmit the input light impinging at the selected angle in a direction with respect to the second curved optical element such that the input light reflected from the second curved optical element is directed in a substantially radial direction relative to the first curved optical element.

4. The optical assembly of claim 1, wherein the input light is generated by a peripheral display, and the angularly selective element is azimuthally graded so that the input light from different portions of the peripheral display is transmitted through the first curved optical element toward the second curved optical element and then reflected from the second curved optical element toward the first curved optical element in a substantially radial direction relative to the first curved optical element.

5. The optical assembly of claim 1, further comprising:
a first waveplate adjacent to the first curved optical element;
a second waveplate adjacent to the second curved optical element; and
a polarized reflector adjacent to the second curved optical element and configured to (1) transmit a first polarized light and (2) reflect a second polarized light, wherein the first polarized light and the second polarized light are orthogonally polarized.

6. The optical assembly of claim 1, wherein the angularly selective element is also configured to reflect the input light coming from the second curved optical element with a substantially reduced transmission.

7. The optical assembly of claim 1, wherein the first curved optical element and the second curved optical element have a same curvature center.

8. The optical assembly of claim 1, wherein the first curved optical element and the second curved optical element have a same radius of curvature.

9. The optical assembly of claim 1, further comprising a mount for the first curved optical element and the second curved optical element, wherein the mount is configured to adjust a first radius of curvature of the first curved optical element and a second radius of curvature of the second curved optical element to correct a direction of transmission of the input light, or an astigmatic focusing of the input light.

10. A virtual reality headset comprising:
a peripheral display including light emitting pixels;
an eyebox delimiting a location of a pupil in a user’s eye; and
an optical assembly, comprising:
an angularly selective element configured to transmit, without reflecting, an input light impinging at a selected angle, through a first curved optical element; and
a second curved optical element in optical series with the first curved optical element and configured to reflect the input light back to the first curved optical element, the first curved optical element reflecting the input light in a radial direction, for transmission through the second curved optical element.

11. The virtual reality headset of claim 10, further comprising an eye tracking device disposed in a central portion relative to the user’s eye, and adjacent to the peripheral display.

12. The virtual reality headset of claim 10, wherein the light emitting pixels in the peripheral display include emitters generating light comprising a narrow bandwidth, a polarization direction, and a beam direction in the selected angle.

13. The virtual reality headset of claim 10 further comprising two eyepieces, wherein the peripheral display includes two conical displays, each of the two conical displays formed in a crescent shape around each of two eyepieces.

14. The virtual reality headset of claim 10, wherein the angularly selective element is azimuthally graded so that the input light from different portions of the peripheral display is transmitted through the first curved optical element toward the second curved optical element and then reflected from the second curved optical element toward the first curved optical element in a substantially radial direction relative to the first curved optical element.

15. A method, comprising:
directing a light beam from a peripheral display onto an angularly selective element at a first angle of incidence, the first angle of incidence selected according to a position of an emitter in the peripheral display and an incident position on a pancake lens adjacent to the angularly selective element;
transmitting the light beam through a first curved optical element and a second curved optical element in the pancake lens, after a first reflection at the second curved optical element and second reflection at the first curved optical element; and
directing the light beam to an eyebox delimiting a pupil position of a user in a virtual reality headset.

16. The method of claim 15, further comprising reflecting a second light beam coming to the incident position at a second angle of incidence that is different from the first angle of incidence.

17. The method of claim 15, wherein the emitter of the peripheral display is a laser, and directing the light beam from the peripheral display comprises directing the laser with a microelectromechanical component.

18. The method of claim 15, wherein transmitting the light beam through a first curved optical element and a second curved optical element comprises rotating a linear polarization of the light beam from a first polarization state to a second polarization state that is orthogonal to the first polarization state between the first curved optical element and the second curved optical element.

19. The method of claim 15, wherein directing a light beam from a peripheral display onto an angularly selective element comprises polarizing the light beam in a linear polarization state.

20. The method of claim 15, further comprising directing a pupil finding beam from an eye tracking device adjacent to the peripheral display towards a user’s eye to identify a location of the user’s pupil within the eyebox.
